(19) United States
(12) Patent Application Publication
(10) Pub. No.: US 2014/0126980 A1
(43) Pub. Date: May 8, 2014

(54) SUBSTRATE PROCESSING APPARATUS

(71) Applicant: TOKYO ELECTRON LIMITED, Tokyo (JP)

(72) Inventors: Yu WAMURA, Oshu-shi (JP); Akira SHIMIZU, Nirasaki City (JP)

(73) Assignee: TOKYO ELECTRON LIMITED, Tokyo (JP)

(21) Appl. No.: 14/071,205

(22) Filed: Nov. 4, 2013

(30) Foreign Application Priority Data
Nov. 6, 2012 (JP) 2012-244777

(51) Int. Cl. B65G 49/00

(52) U.S. Cl. CPC B65G 49/00
USPC 414/221

(57) ABSTRACT

Provided is a substrate processing apparatus which includes: first and second vacuum transfer chambers which are partitioned from each other; processing chambers configured to perform a vacuum processing onto substrates; a load lock chamber installed to be sandwiched between the first and second vacuum transfer chambers, and including partition valves installed between the load lock chamber and a normal pressure atmosphere, and between the load lock chamber and each of the first and second vacuum transfer chambers; and substrate mounting tables inside the load lock chamber and configured to move between an upper position at which the substrates are transferred between the load lock chamber and the normal pressure atmosphere, and a lower position at which the substrates are transferred between the load lock chamber and the first or second vacuum transfer chamber.

### CROSS-REFERENCE TO RELATED APPLICATION

This application claims the benefit of Japanese Patent Application No. 2012-244777, filed on Nov. 6, 2012, in the Japan Patent Office, the disclosure of which is incorporated herein in its entirety by reference.

### TECHNICAL FIELD

The present disclosure relates to a technique for carrying substrates into/out of a substrate processing apparatus including a plurality of processing chambers in which the substrates are vacuum-processed.

### BACKGROUND

In a process of manufacturing a semiconductor device, a substrate processing apparatus called a multi chamber or a cluster tool is used. The substrate processing apparatus includes a plurality of processing chambers for vacuum processing which is connected to a common vacuum transfer chamber including a transfer mechanism of semiconductor wafers (hereinafter referred to as “wafers”). The vacuum transfer chamber is connected to a vacuum preliminary chamber called a load lock chamber whose interior may be switched between a normal pressure atmosphere and a vacuum atmosphere.

For example, a substrate processing apparatus includes load lock chambers that are connected to a side wall of a vacuum transfer chamber. The load lock chambers of the substrate processing apparatus are designed such that their interiors are switched between a normal pressure atmosphere and a vacuum atmosphere. Using the load lock chambers, the wafers are transferred between the vacuum transfer chamber and the outside while maintaining the vacuum transfer chamber at the vacuum atmosphere.

However, to improve productivity, the diameter of the wafers which are processed in the substrate processing apparatus has been increasing. In recent years, the development of a substrate processing apparatus which is capable of processing wafers having a diameter of 450 mm has been promoted. The increase in diameter of a wafer causes an increase in size of processing chambers and load lock chambers, which results in an increase in a footprint of the substrate processing apparatus.

In addition, since the load lock chambers are not devices for processing wafers, in a case where the vacuum transfer chambers and the load lock chambers are laterally arranged, the increase in size of the load lock chambers hinders a restricted space of the substrate processing apparatus from being used more efficiently.

Moreover, in a case where a plurality of processing chambers is connected to a single vacuum transfer chamber, when a maintenance check of a transfer mechanism installed in the single vacuum transfer chamber is needed, none of the processing chambers may be used. This results in very low productivity.

SUMMARY

Some embodiments of the present disclosure provide to a substrate processing apparatus which is capable of arranging vacuum transfer chambers and load lock chambers in a restricted space with high efficiency and continuing to a substrate processing even when some of the vacuum transfer chambers are out of service.

According to an embodiment of the present disclosure, a substrate processing apparatus which includes: first and second vacuum transfer chambers which are air-tightly partitioned from each other and are laterally arranged adjacent to each other, each being equipped with a substrate transfer mechanism; processing chambers configured to perform a vacuum processing onto substrates, the processing chambers being laterally arranged to be air-tightly connected to each of the first and second vacuum transfer chambers; a first load lock chamber installed to be sandwiched between the first and second vacuum transfer chambers, and including a first set of partition valves installed between the first load lock chamber and a normal pressure atmosphere kept at upper sides of the first and second vacuum transfer chambers, and between the first load lock chamber and each of the first and second vacuum transfer chambers; and substrate mounting tables provided within the first load lock chamber and configured to move between an upper position at which the substrates are transferred between the first load lock chamber and the normal pressure atmosphere, and a lower position at which the substrates are transferred between the first load lock chamber and the first or second vacuum transfer chamber, the substrates being horizontally mounted on the substrate mounting tables.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a vertical cross-sectional view of the film forming apparatus according to an embodiment of the present disclosure.

FIG. 2 is an exploded perspective view showing an internal configuration of the film forming apparatus.

FIG. 3 is a traverse cross-sectional view of the film forming apparatus taken along line A-A′ in FIG. 1.

FIG. 4 is a traverse sectional view of a film forming module in the film forming apparatus.

FIG. 5 is an exploded perspective view showing a configuration of a carrier mounting table provided in the film forming apparatus.

FIG. 6 is a traverse cross-sectional view of the film forming apparatus 1 taken along line B-B′ in FIG. 1.

FIG. 7 is a traverse cross-sectional view of a film forming apparatus according to another embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

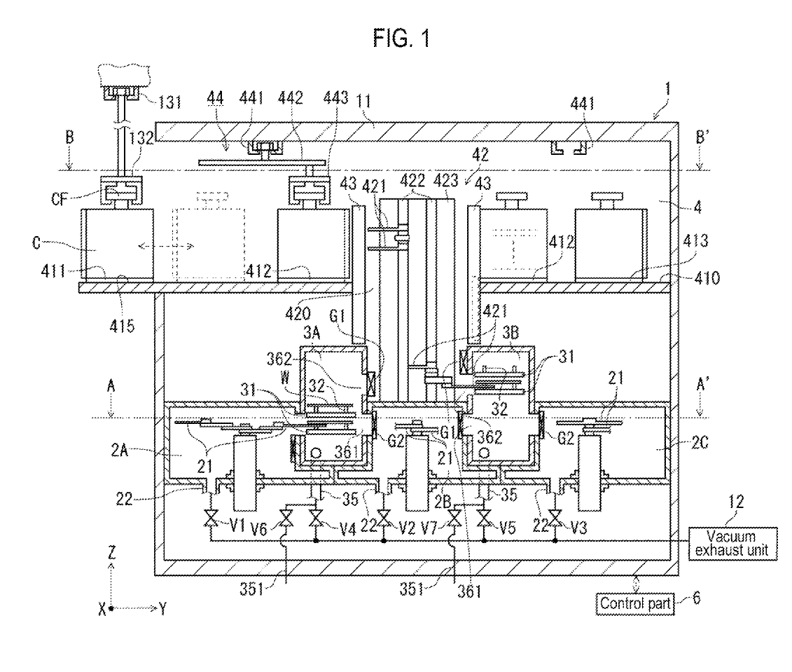

With reference to FIGS. 1 to 6, a film forming apparatus 1 according to an embodiment of the present disclosure will now be described. The film forming apparatus 1 includes a plurality of film forming modules 5, each of which is configured to perform a film forming process onto wafers.

FIG. 1 is a vertical cross-sectional view of the film forming apparatus 1. As shown in FIG. 1, the film forming apparatus 1 includes a housing 11 as an outer covering body. The interior of the housing 11 is vertically partitioned into an upper sector and a lower sector by a partition plate 410. In the upper sector, a carrier mounting zone 4 in which a carrier C (as a transfer container) accommodates wafers W is defined. In the lower sector, the wafers W taken out of the carrier C are transferred and subjected to a film forming process.

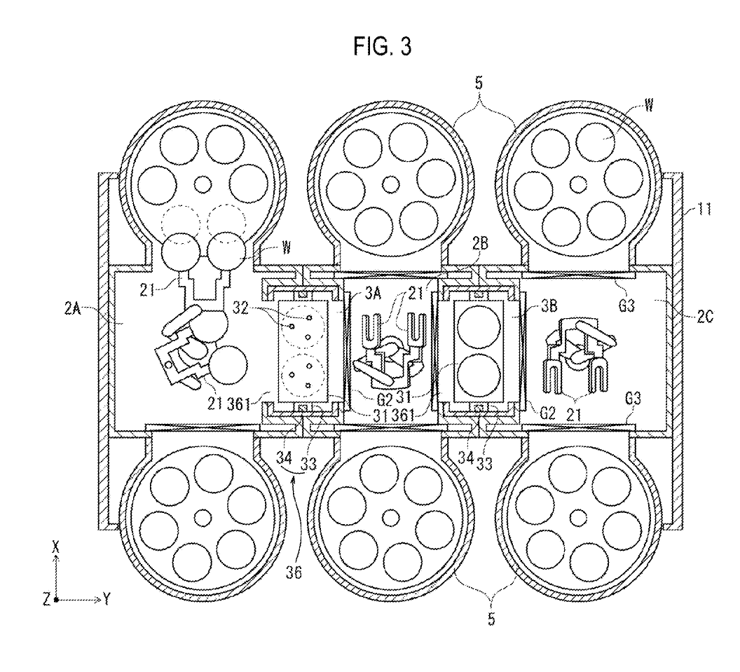

As shown in FIGS. 1 to 3, in the lower sector defined below the partition plate 410, vacuum transfer chambers 2A to 2C are air-tightly separated from one another are arranged adjacent to each other in a line. Each of the vacuum transfer chambers 2A to 2C is provided with a set of transfer arms 21 (as a substrate transfer mechanism) configured to transfer the wafers W. The set of the transfer arms 21 is equipped with two forks configured to support the wafers W such that two sheet of the wafers W can be transferred by the two forks at once. FIG. 3 is a traverse cross-sectional view of the film forming apparatus 1 taken along line A-A′ in FIG. 1. In FIG. 1, a portion of the transfer arms 21 installed in each of the vacuum transfer chambers 2B and 2C is not shown for the sake of simplicity.

In this embodiment, the vacuum transfer chambers 2A and 2B may be referred to as first and second vacuum transfer chambers, respectively. The vacuum transfer chamber 2C may be referred to as a third vacuum transfer chamber which is disposed, and may be located opposite to the first vacuum transfer chamber 2A with the second vacuum transfer chamber 2B interposed therebetween. In the following description, with respect to a direction (Y direction in FIG. 1) in which the vacuum transfer chambers 2A to 2C are arranged in a line, one side in which the vacuum transfer chamber 2A is disposed is a front side of the film forming apparatus 1 and the other side in which the vacuum transfer chamber 2C is disposed is an inner side of the film forming apparatus 1.

The vacuum transfer chambers 2A to 2C are connected to upper ends of respective vacuum-evacuation lines 22, respectively. Lower ends of the vacuum-evacuation lines 22 are connected to a common vacuum-evacuation unit 12 such as a vacuum pump. Opening/closing valves V1 to V3 are installed in the respective vacuum-evacuation lines 22. The opening/closing valves V1 to V3 are opened to perform vacuum-evacuation, thereby allowing the interior of each of the vacuum transfer chambers 2A to 2C to be maintained at the vacuum atmosphere.

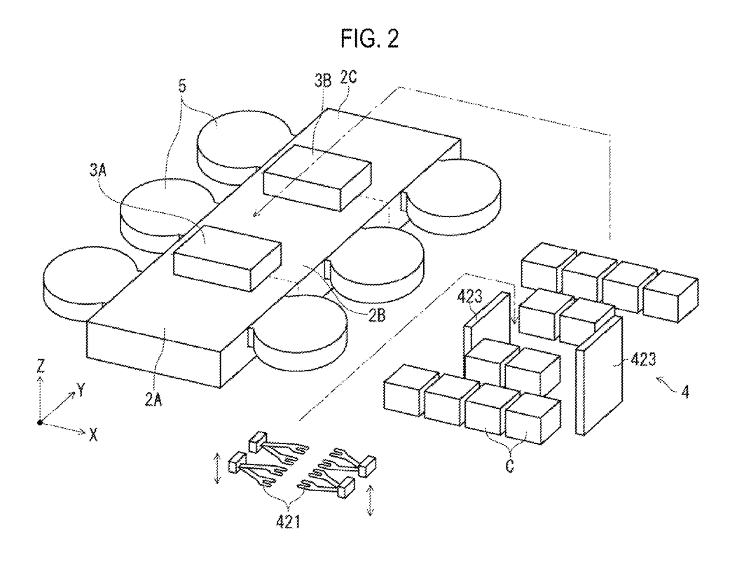

When viewed from the front side of the film forming apparatus 1, the plurality of (e.g., six) film forming modules 5 configured to perform a film forming process as a kind of vacuum process is hermetically connected to both left and right sides of each of the vacuum transfer chambers 2A to 2C via respective gate valves G3 (see FIGS. 2 and 3). In the film forming apparatus 1 according to this embodiment, as described above, a total of the six film forming modules 5 are provided with two film forming modules 5 for each of the vacuum transfer chambers 2A to 2C.

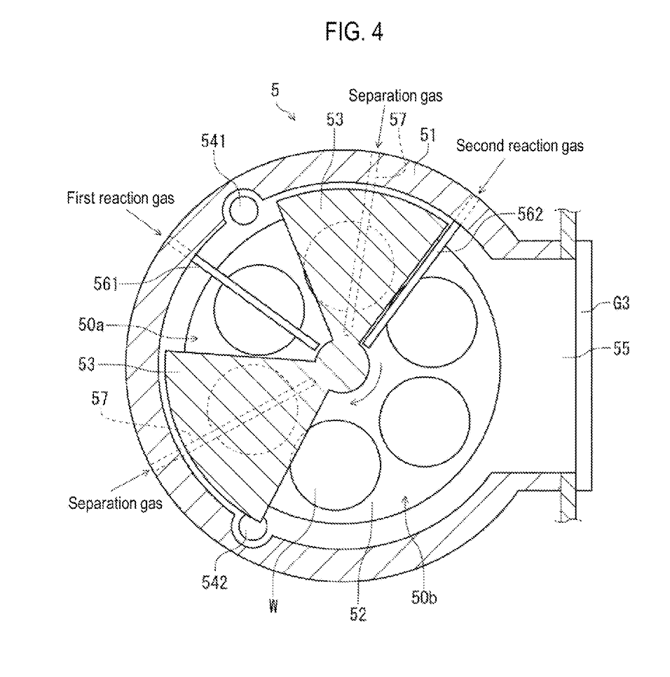

As shown in FIG. 4, each of the film forming modules 5 includes an air-tight flat processing container 51 of a cylindrical shape as a processing chamber, and a rotatable table 52 which is disposed within the processing container 51 and is horizontally rotatable around its central axis extending in a vertical direction. In this embodiment, six wafers W may be circumferentially arranged and mounted on the rotatable table 52, but the number of wafers is not limited thereto. As described above, when the set of transfer arms 21 configured to transfer the two wafers W at once is used, the even number of the wafers W are mounted so as to implement an efficient transfer operation. A heater (not shown) configured to heat the wafers W mounted on the rotatable table 52 is disposed below the rotatable table 52.

Two fan-shaped convex portions 53, which project downward from a ceiling of the processing container 51, are provided in a space defined between the ceiling and an upper surface of the rotatable table 52. The space is divided into two processing sectors 50a and 50b by the convex portions 53. Reaction gas nozzles 561 and 562, which are configured to supply first and second reaction gases reacting with each other therethrough, are installed to be radially inserted into the two processing sectors 50a and 50b over the upper surface of the rotatable table 52. Each of the reaction gas nozzles 561 and 562 includes a plurality of gas supply holes (not shown) formed along its longitudinal direction such that the first and second reaction gases are discharged downward through the plurality of gas supply holes.

Exhaust ports 541 and 542 through which the processing sectors 50a and 50b are respectively vacuum-evacuated are formed below a lateral side of the rotatable table 52. The first and second reaction gases supplied from the reaction gas nozzles 561 and 562 are exhausted through the exhaust ports 541 and 542 to the outside while passing over surfaces of the wafers W mounted on the rotatable table 52. In order to prevent the first and second reaction gases supplied into the processing sectors 50a and 50b from being mixed with each other, separation gas nozzles 57 are respectively installed in the convex portions 53. Specifically, each of the separation gas nozzles 57 supplies a separation gas such as nitrogen gas into a gap formed between the upper surface of the rotatable table 52 and lower surfaces of the convex portions 53.

In each of the film forming modules 5 configured as above, the wafers W to be processed which are carried out of each of the vacuum transfer chambers 2A to 2C are mounted on the rotatable table 52 via an inlet/outlet 55. When the gate valve G3 is closed and the rotatable table 52 is rotated, the wafers W mounted on the rotatable table 52 pass alternately through the processing sectors 50a and 50b. Subsequently, the first and second reaction gases are supplied from the reaction gas nozzles 561 and 562 while heating the wafers W. Then, a process of the first reaction gas being adsorbed onto the wafers W and the reaction between the first reaction gas adsorbed onto the wafers W and the second reaction gas is repeatedly performed. In this way, each of the film forming modules 5 according to this embodiment can perform the film forming process using an ALD (Atomic Layer Deposition) method or a MLD (Molecular Layer Deposition) method (hereinafter collectively referred to as an “ALD method”) which forms a thin film on each surface of the wafers W by depositing atomic or molecular layers on the surfaces.

The wafers W to be processed are carried into and out of the film forming module 5 via the vacuum transfer chambers 2A to 2C whose interior is maintained at the vacuum atmosphere. Meanwhile, in the carrier mounting zone 4 defined above the partition plate 410, the wafers W are carried into and out of the carrier C under the normal pressure atmosphere. This configuration requires transferring the wafers W between the carrier C and the vacuum transfer chambers 2A to 2C while maintaining the vacuum transfer chambers 2A to 2C and the film forming modules 5 at the vacuum atmosphere. To meet this requirement, in the lower sector defined below the partition plate 410 are provided two load lock chambers 3A and 3B whose interiors thereof are switchable between the normal pressure atmosphere and the vacuum atmosphere. Through the load lock chambers 3A and 3B, the wafers W are transferred between the carrier C and the vacuum transfer chambers 2A to 2C.

In the film forming apparatus 1 of this embodiment, the load lock chambers 3A and 3B are installed to be interposed between the vacuum transfer chambers 2A to 2C, and are arranged adjacent to one another in a line. Specifically, the load lock chamber 3A is disposed between the vacuum transfer chambers 2A and 2B and the load lock chamber 3B is disposed between the vacuum transfer chambers 2B and 2C. As shown in FIGS. 1 to 3, the load lock chambers 3A and 3B are respectively sandwiched between the vacuum transfer chambers 2A-2B and 2B-2C, and are vertically-extended rectangular containers adjacent to each other at their lower portions. On the other hand, upper portions of the load lock chambers 3A and 3B are protruded upward relative to the ceilings of the vacuum transfer chambers 2A to 2C such that the upper portions of the load lock chambers 3A and 3B are exposed to the normal pressure atmosphere maintained below the partition plate 410.

Lower inlet/outlets 361 are respectively formed at side walls of the lower portions of the load lock chambers 3A and 3B. The lower inlet/outlets 361 are opened/closed by respective gate valves G2 so that the lower inlet/outlets 361 are in communication with the respective vacuum transfer chambers 2A to 2C. Through the lower inlet/outlets 361, the transfer arms 21 installed within each of the vacuum transfer chambers 2A and 2B can advance into the load lock chamber 3A, and the transfer arms 21 installed within each of the vacuum transfer chambers 2B and 2C can advance into the load lock chamber 3B.

Further, upper inlet/outlets 362 which are opened/closed by respective gate valves G1 are respectively formed in the side walls of the upper portions of the load lock chambers 3A and 3B which are protruded upward relative to the vacuum transfer chambers 2A to 2C. The upper inlet/outlets 362, which are formed at the side walls of the load lock chambers 3A and 3B which face each other, are opened such that vertical transfer arms 421 (which will be described later) can be advanced into the load lock chambers 3A and 3B via the upper inlet/outlets 362. The gate valves G1 installed in the load lock chambers 3A and 3B act as partition valves for partitioning between the load lock chambers 3A and 3B and the normal pressure atmosphere of the upper portions of the load lock chambers 3A and 3B. The gate valves G2 installed in the load lock chambers 3A and 3B act as partition valves for partitioning between the load lock chambers 3A and 3B and the vacuum transfer chambers 2A to 2C.

As shown in FIGS. 1 and 3, in each of the load lock chambers 3A and 3B, two upper and lower wafer mounting tables 31 (as substrate mounting tables) made of planar rectangular plate material are vertically placed at a certain interval in a shelf fashion. Two wafer mounting regions are formed on an upper surface of each of the wafer mounting tables 31. Two wafers W are mounted at left and right sides of the two wafer regions when viewed from the front side of the film forming apparatus 1. For example, three supporting pins 32 are installed in each of the wafer mounting regions. The wafers W are supported by the supporting pins 32 so that they are horizontally mounted on the wafer mounting tables 31.

As shown in FIG. 3, elevation mechanisms 37 are installed at left and right sides of the wafer mounting tables 31 when viewed from the front side of the film forming apparatus 1. Each of the elevation mechanisms 36 includes an elevation rail 34 vertically extending along an inner wall of each of the load lock chambers 3A and 3B, and a slider 33 which supports the wafer mounting tables 31 and travels along the elevation rail 34. The slider 33 is vertically movable by a drive mechanism (not shown) so that the wafer mounting tables 31 is moved between an upper position corresponding to the upper inlet/outlet 362 and a lower position corresponding to the lower inlet/outlet 361 (see FIG. 1).

The load lock chambers 3A and 3B are connected to vacuum-evacuation lines 35 equipped with opening/closing valves V4 and V5, respectively. Lower ends of the vacuum-evacuation lines 35 are connected to the aforementioned common vacuum-evacuation unit 12. In addition, each of the vacuum-evacuation lines 35 are branched at an upstream side of each of the opening/closing valves V4 and V5 to form an air introduction line 351. Through the air introduction lines 351, an external normal pressure atmosphere is introduced into the load lock chambers 3A and 3B. Opening/closing valves V6 and V7 are respectively installed in the air introduction lines 351. When the opening/closing valves V6 and V7 of the air introduction lines 351 are closed and the opening/closing valves V4 and V5 of the vacuum-evacuation lines 35 are opened, the interiors of the load lock chambers 3A and 3B are vacuum-exhausted. On the other hand, when the opening/closing valves V6 and V7 of the air introduction lines 351 are opened and the opening/closing valves V4 and V5 of the vacuum-evacuation lines 35 are closed, the interiors of the load lock chambers 3A and 3B are maintained at the normal pressure atmosphere. In this manner, the interiors of the load lock chambers 3A and 3B can be freely switched between the vacuum atmosphere and the normal pressure atmosphere.

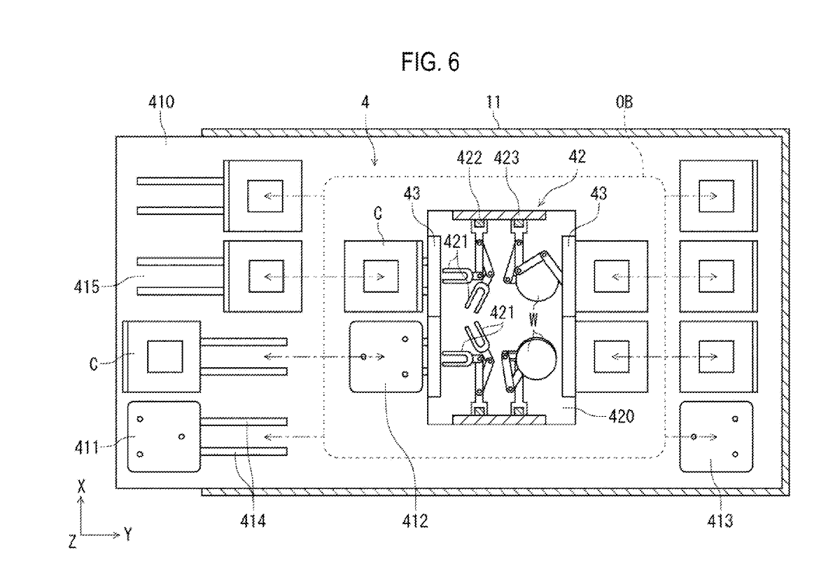

A vertical transfer mechanism 42 is arranged between the load lock chambers 3A and 3B which are installed to be protruded upward relative to the upper sides of the vacuum transfer chambers 2A to 2C. Specifically, the vertical transfer mechanism 42 is arranged to vertically pass through the partition plate 410 so as to transfer the wafers W between the upper sector (i.e., the carrier mounting zone 4) and the lower sector. As shown in FIGS. 1, 2 and 6, the vertical transfer mechanism 42 includes a set of side plates 423 arranged in the vicinity of left and right sides of the load lock chambers 3A and 3B when viewed from the front side of the film forming apparatus 1, two sets of vertically-extended elevation rails 422 which are arranged in the set of side plates 423, and four sets of vertical transfer arms 421 which are configured to vertically move along the two sets of elevation rails 422. FIG. 6 is a traverse cross-sectional view of the film forming apparatus 1 taken along line B-B′ in FIG. 1.

The set of side plates 423 are installed to extend upward in the vicinity of the upper portions of the load lock chambers 3A and 3B which are protruded upward relative to the vacuum transfer chambers 2A to 2C. The set of side plates 423 pass through an access port 420 formed in the partition plate 410 up to the interior of the carrier mounting zone 4. The two sets of elevation rails 422 are installed in inner surfaces of the respective side plates 423. Each of the four sets of vertical transfer arms 421, which includes two forks configured to support the wafers W, is installed in the respective elevation rail 422. The two forks in each of the four sets of vertical transfer arms 421 can be advanced into the load lock chambers 3A and 3B through the upper inlet/outlets 362 and into the carrier C positioned near the access port 420 through the access port 420.

The carrier mounting zone 4 defined above the partition plate 410 includes a loading/unloading port 415, carrier mounting tables (container mounting tables) 412, and intermediate delivery tables 413. Through the loading/unloading port 415, the carriers C are transferred into and from the film forming apparatus 1 using an outer OHT (Overhead Hoist Transport) 132 as a ceiling transfer mechanism which moves along a traveling rail 131 installed inside a factory. The carrier mounting tables 412 are used for transferring the wafers W between the load lock chambers 3A and 3B using the vertical transfer mechanism 42. The intermediate delivery tables 413 are installed in a transfer path along which the carriers C are transferred between the loading/unloading port 415 and the carrier mounting tables 412. The intermediate delivery tables 413 temporarily mount the carriers C thereon.

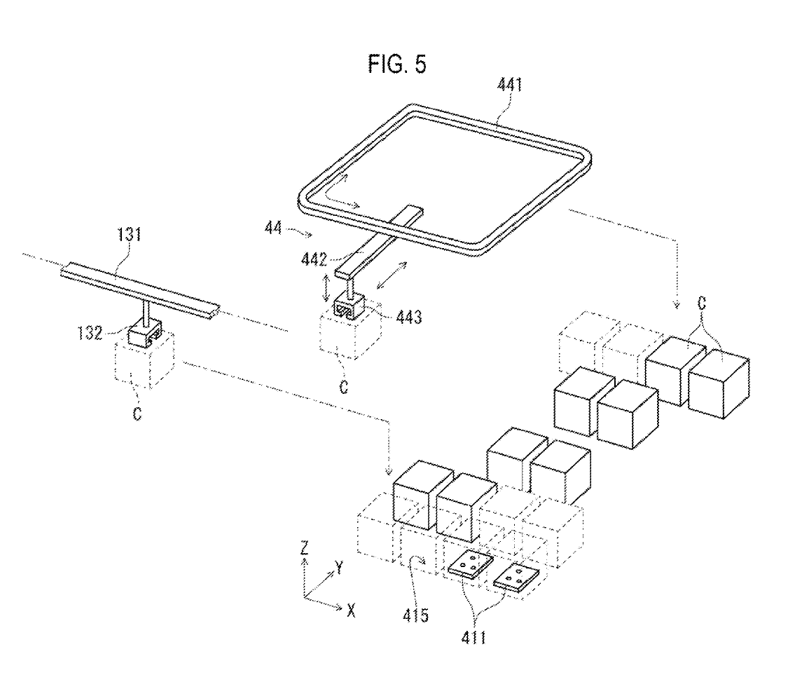

As shown in FIGS. 1 and 6, a front surface of the housing 11 of the film forming apparatus 1 is opened to expose the carrier mounting zone 4. The partition plate 410 is installed to protrude toward the front side of the film forming apparatus 1 through the opened portion. The loading/unloading port 415 is formed on the upper surface of the partition plate 410 in the protruded portion. Through the loading/unloading port 415, the carriers C are transferred by the outer OHT 132. A plurality of mounting tables 411 is disposed in the loading/unloading port 415. Specifically, the mounting tables 411 are configured to move in a front-back direction, i.e., between the loading/unloading port 415 and an inner side (an introduction position defined inside the housing 11) of the loading/unloading port 415 along respective rails 414. As shown in FIGS. 5 and 6, in this embodiment, when viewed from the front side of the film forming apparatus 1, four mounting tables 411 are horizontally arranged side by side in the loading/unloading port 415.

Each of the carrier mounting tables 412 is a plate-like mounting table capable of mounting the carrier C thereon. In this embodiment, a set of two carrier mounting tables 412 is arranged in each of front and rear sides of the access port 420. The access port 420 through which the vertical transfer mechanism 42 penetrates is interposed between each of front and rear sides of the access port 420. For example, each of the carriers C is a FOUP (Front Opening Unified Pod) whose cover disposed in its front side is capable of being opened/closed. In this case, a cover opening/closing mechanism 43 configured to close/open the cover are arranged at positions facing the access port 420. The carrier C is mounted on the carrier mounting table 412 with the front side of the carrier C faced the cover opening/closing mechanism 43. The carrier mounting table 412 is configured to move forward and backward between a position at which the carrier C is connected to the cover opening/closing mechanism 43 and a position at which the carrier C is disconnected from the cover opening/closing mechanism 43. In this embodiment, the carrier mounting tables 412 has been described to be arranged above the load lock chambers 3A and 3B, but is not limited thereto. In some embodiments, the carrier mounting tables 412 may be provided above the vacuum transfer chambers 2A to 2C as long as the vertical transfer arms 421 can be advanced into the respective carrier mounting tables 412, or as long as intermediate transfer mechanisms configured to transfer the wafers W between the carrier C and the vertical transfer arms 421 are employed.

In the inner side of the carrier mounting zone 4 when viewed from the front side of the film forming apparatus 1, for example, the four intermediates delivery tables 413are arranged in a left-right direction side by side as shown in FIG. 6. The four intermediates delivery tables 413 are configured to temporarily mount the carriers C loaded through the loading/unloading port 415 or empty carriers C having no wafer W therein (out of which the wafers W have been picked up in the carrier mounting tables 412). For example, each of the intermediate delivery tables 413 is constructed as a plate mounting table capable of mounting the carrier C thereon.

The transfer of the carriers C between the mounting tables 411 (positioned at the introduction position), the carrier mounting tables 412 and the intermediate delivery tables 413 is performed by a carrier transfer mechanism 44 used as a container transfer mechanism. As shown in FIG. 5, the carrier transfer mechanism 44 includes a horizontal arm 442 configured to travel along a traveling rail 441 (used as a traveling path member) installed at the ceiling of the housing 11, and an inner OHT 443 supported by the horizontal arm 442.

As shown in FIG. 5, the traveling rail 441 has a square ring-shaped track. As indicated by a dashed line “OB” in FIG. 6, the traveling rail 441 is configured to surround the access port 420 and is arranged such that the horizontal arm 442 can be moved over the mounting tables 411 (positioned at the introduction position), the carrier mounting tables 412 and the intermediate delivery tables 413. The horizontal arm 442 is an elongated plate member extending in a direction orthogonal to the track of the traveling rail 441. As the horizontal arm 442 is moved along the traveling rail 441, the horizontal arm 442 passes over the carriers C which are mounted on the mounting tables 411 (positioned at the introduction position), the carrier mounting tables 412 and the intermediate delivery tables 413.

The inner OHT 443 may horizontally and vertically be moved along the horizontal arm 442. The inner OHT 443 grasps and lifts up a flange CF installed on an upper surface of each of the carriers C so as to transfer each of the carriers C. Specifically, the horizontal arm 442 is moved along the traveling rail 441 and the inner OHT 443 is moved along the horizontal arm 442 so that the carriers C can be transferred between the mounting tables 411 (positioned at the introduction position), the carrier mounting tables 412 and the intermediate delivery tables 413, as indicated by a one-dot chain line arrow in FIG. 6. In this embodiment, the horizontal arm 442 corresponds to a main transfer mechanism and the inner OHT 443 corresponds to a sub transfer mechanism. In this embodiment, the mounting tables 411, which move the carriers C from the loading/unloading port 415 to the introduction position, may serve as one component of the container transfer mechanism which transfers the carriers C between the loading/unloading port 415 and the carrier mounting tables 412 or the intermediate delivery tables 413.

In some embodiments, the carrier transfer mechanism 44 may move up to be above the carriers C mounted on the mounting tables 411 (positioned at the introduction position), the carriers C mounted on the carrier mounting tables 412 and the carriers C mounted on the intermediate delivery tables 413. Alternatively, the carrier transfer mechanism 44 may move along lateral sides of the carriers C. Although a gap between the carriers C and the ceiling of the housing 11 or a distance between the carriers C is shown to be narrow in FIG. 1 for the sake of simplicity, in practice, the gap may be designed to allow the carriers C to be transferred free of interference therebetween.

The film forming apparatus 1 is connected to a control unit 6 implemented with a computer including a CPU and a storage unit. The storage unit stores a program for executing a group of steps (instructions) which outputs control signals to operate various components built in the film forming apparatus 1. This program is stored in a storage medium such as a hard disk, a compact disk, a magneto-optical disk, a memory card or the like. Further, the program may be installed in the storage unit from the storage medium.

An operation of the film forming apparatus 1 configured as above will now be described. First, a carrier C with wafers W to be processed is accommodated in the film forming apparatus 1, and is transferred by the outer OHT 132. When the outer OHT 132 reaches above the loading/unloading port 415, the outer OHT 132 descends to mount the carrier C on the mounting table 411 positioned in the loading/unloading port 415, as shown in FIG. 1. Subsequently, the mounting table 411 on which the carrier C is mounted is moved to the introduction position. At the introduction position, the carrier transfer mechanism 44 picks up the carrier C mounted on the mounting table 411.

When there is a carrier mounting table 412 on which the transfer of the wafers W is not being performed (i.e., on which any carrier C is not mounted, or the carrier mounting table 412 is empty), the carrier transfer mechanism 44 moves other carrier C to the empty carrier mounting table 412 and mounts the same thereon. Meanwhile, without the empty carrier mounting table 412, the carrier transfer mechanism 44 moves the carrier C to the intermediate delivery table 413 and mounts the same thereon. When another empty carrier mounting table 412 is present, the carrier transfer mechanism 44 picks up the carrier C mounted on the mounting table 411 or the intermediate delivery table 413 and transfers the same to the another empty mounting table 412.

Subsequently, if the carrier mounting table 412 is connected to the cover opening/closing mechanism 43, the cover of the carrier C mounted on the carrier mounting table 412 is opened. Then, vertical transfer arms 421 advance into the carrier C to pick up the wafers W to be processed. Thereafter, the vertical transfer arms 421 are moved downward while holding the picked up wafers W. At this time, the load lock chambers 3A and 3B to which the vertical transfer arms 421 are accessible, are maintained at a state where interiors of the load lock chambers 3A and 3B are switched to the normal pressure atmosphere by closing the gate valves G2 installed in the lower inlet/outlets 361 and opening the gate valves G1 installed in the upper inlet/outlets 362.

The vertical transfer arms 421 advance into the opened load lock chamber 3A (or 3B) and transfers the picked up wafers W on the upper and lower mounting tables 31. In this way, as described above, the two wafers W to be processed are mounted on the upper wafer mounting table 31 and the two wafers W to be processed are mounted on the lower wafer mounting table 31a so that a total of four wafers W to be processed are mounted on the upper and lower wafer mounting tables 31. Subsequently, the vertical transfer arms 421 are retreated from the opened load lock chamber 3A (or 3B) and the gate valve G1 installed in the upper inlet/outlet 362 is hermitically closed. Thereafter, the interior of the load lock chamber 3A (or 3B) which has been opened is vacuum-evacuated through the vacuum-evacuation line 35.

Subsequently, for example, when the interior of the load lock chamber 3A is kept at a predetermined degree of vacuum which allows for communication with any one of the vacuum transfer chambers 2A and 2B, the wafer mounting tables 31 are moved downward while opening the gate valve G2 of the lower inlet/outlet 361 facing any one (e.g., 2A) of the vacuum transfer chambers 2A and 2B where the transfer of the wafers W is performed. Then, the transfer arms 21 advance into the opened load lock chamber 3A via the lower inlet/outlet 361 and pick up the wafers W to be processed.

As shown in FIG. 3, the transfer arms 21 load the picked up wafers W to be processed into the primary one of the film forming modules 5 connected to the vacuum transfer chamber 2A until six wafers W to be processed are mounted on the rotatable table 52 of the primary film forming module 5. In this way, when the six wafers W to be processed are mounted on the rotatable table 52, the gate valve G3 is closed such that the film forming process is performed within the primary film forming module 5.

In the meantime, the transfer arms 21 advance into the secondary one of the film forming modules 5 by opening the gate valve G3 to extract the processed wafers W previously received therein. The extracted processed wafers W are loaded into the load lock chamber 3A where the extracted processed wafers W are mounted on the wafer mounting tables 31. Thereafter, the gate valve G2 of the lower inlet/outlet 361 is closed and an external air is introduced into the load lock chamber 3A via the air introduction line 351. Thus, the internal atmosphere of the load lock chamber 3A is changed into the normal pressure atmosphere. Then, the wafer mounting tables 31 are moved upward and simultaneously the gate valve G1 of the upper inlet/outlet 362 is opened such that the vertical transfer arms 421 of the vertical transfer mechanism 42 advance into the load lock chamber 3A to pick up the processed wafers W extracted from the vacuum transfer chamber 2A.

At this time, a carrier C waits at the carrier mounting table 412 to accommodate the processed wafers W therein. The vertical transfer arms 421 advance into the waiting carrier C to transfer the processed wafers W. In some embodiments, the carrier C out of which the wafers W are previously carried may wait at the carrier mounting table 412, or may be retreated toward the intermediate delivery table 413 in order to avoid interference with a carry operation of wafers W into/out of another adjacent carrier C.

When a predetermined number of wafers W are carried into the waiting carrier C and the cover installed in the waiting carrier C is closed, the carrier transfer mechanism 44 transfers the carrier C from the carrier mounting table 412 up to the mounting table 411 waiting at the introduction position. When the carrier C is mounted on the mounting table 411, the mounting table 411 moves the carrier C to the loading/unloading port 415 such that the carrier C is transferred to the outside by the outer OHT 132.

In the film forming apparatus 1 configured to perform the film forming process in this manner, for example, a maintenance check of the transfer arms 21 arranged in the vacuum transfer chamber 2B (positioned at the center) is needed. In this case, the lower inlet/outlet 361 facing the vacuum transfer chamber 2B is closed by the gate valve G2 such that the vacuum transfer chamber 2B is isolated from the load lock chamber 3A (or 3B) and the vacuum transfer chambers 2A and 2C.

Thereafter, the internal atmosphere of the vacuum transfer chamber 2B is changed into the normal pressure atmosphere and the film forming modules 5 connected to the vacuum transfer chamber 2B are removed to open the vacuum transfer chamber 2B, thereby performing the maintenance check of the transfer arms 21. On the other hand, since the load lock chambers 3A and 3B are separated from the vacuum transfer chamber 2B by closing the gate valves G2, the internal atmospheres of the load lock chambers 3A and 3B can be maintained at the vacuum atmosphere. Thus, the wafers W to be processed are transferred between the load lock chamber 3A and the vacuum transfer chamber 2A and between the load lock chamber 3B and the vacuum transfer chamber 2C, thereby allowing the film forming process to be performed inside each of the film forming modules 5 connected to each of the vacuum transfer chambers 2A and 2C.

For example, as shown in FIG. 3, in the case where a total of the six film forming modules 5 are connected to the vacuum transfer chambers 2A to 2C, when the maintenance check of the vacuum transfer chamber 2B positioned at the center is performed, the film forming process can continue to be performed in the remaining four film forming modules 5 connected to the vacuum transfer chambers 2A and 2C. With this configuration, if there is no restriction to a transfer system, it is possible to maintain an operating rate of about 67% as compared with a case where all of the film forming modules 5 are operated. The same is also true in a case where any one of the vacuum transfer chamber 2A and 2C needs to be disconnected. Thus, even in such a case, it is possible to maintaining the operating rate of about 67%.

For example, a case where a maintenance check is needed in the load lock chamber 3A disposed at the front side will be described. In this case, by closing the gate valves G2 of the lower inlet/outlets 361 arranged between the load lock chamber 3A and the vacuum transfer chambers 2A and 2B, the load lock chamber 3A as a target for a maintenance check is separated from the vacuum transfer chambers 2A and 2B.

With this configuration, even when the maintenance check of the load lock chamber 3A (positioned at the front side) is performed, since the vacuum transfer chamber 2B (positioned at the center) and the vacuum transfer chamber 2C (positioned at the rear side) are in communication with the load lock chamber 3B, the transfer of the wafers W can be performed therebetween. Further, the film forming modules 5 connected to each of the vacuum transfer chambers 2B and 2C can continue to be used. Accordingly, even in this example, four of the six film forming modules 5 can continue to be used. Similarly, it is possible to maintain the operating rate of about 67% if there is no restriction to the transfer system. This may be similarly applied to a case where maintenance check is needed in the load lock chamber 3B positioned at the rear side.

The film forming apparatus 1 according to the above embodiment has the following effects. In the load lock chambers 3A and 3B, since the transfer of wafers W is performed under the normal pressure atmosphere at the upper sides of the vacuum transfer chambers 2A to 2C, it is possible to arrange the vacuum transfer chambers 2A to 2C and the load lock chambers 3A and 3B in a narrow area with high efficiency.

In this manner, by stacking and arranging the load lock chambers 3A and 3B on the vacuum transfer chambers 2A to 2C, it is possible to reduce a footprint of equipment required for a wafer transfer system. In the arrangement of the film forming modules 5 shown in FIG. 3, a ratio of the total area of the wafers W arranged in each of the film forming modules 5 to the footprint of the film forming apparatus 1 (in a case where a total of 36 wafers are accommodated, with 6 wafers for each of the film forming modules 5) was calculated to be about 25%.

On the other hand, in the conventional substrate processing apparatus, a ratio of total area of 6 wafers W to a footprint of the conventional substrate processing apparatus was calculated to be about 7%. Therefore, according to the film forming apparatus 1 of this embodiment, it is possible to make the most of the restricted footprint in processing of wafers W.

In addition, the vacuum transfer chambers 2A to 2C are arranged adjacent to each other in a line and the load lock chambers 3A and 3B are respectively sandwiched between the vacuum transfer chambers 2A-2B and 2B-2C. Further, the load lock chambers 3A and 3B include partition valves (i.e., the gate valves G1 and G2) such that the load lock chambers 3A and 3B are selectively in communication with the normal pressure atmosphere and the vacuum transfer chambers 2A to 2C. With this configuration, the vacuum transfer chambers 2A to 2C may be independently separated from the load lock chambers 3A and 3B. This allows, even when some of the vacuum transfer chambers 2A to 2C are not operating, the remaining vacuum transfer chambers to continue to be used. Thus, the film forming modules 6 connected to the remaining vacuum transfer chambers can continue to perform the film forming process.

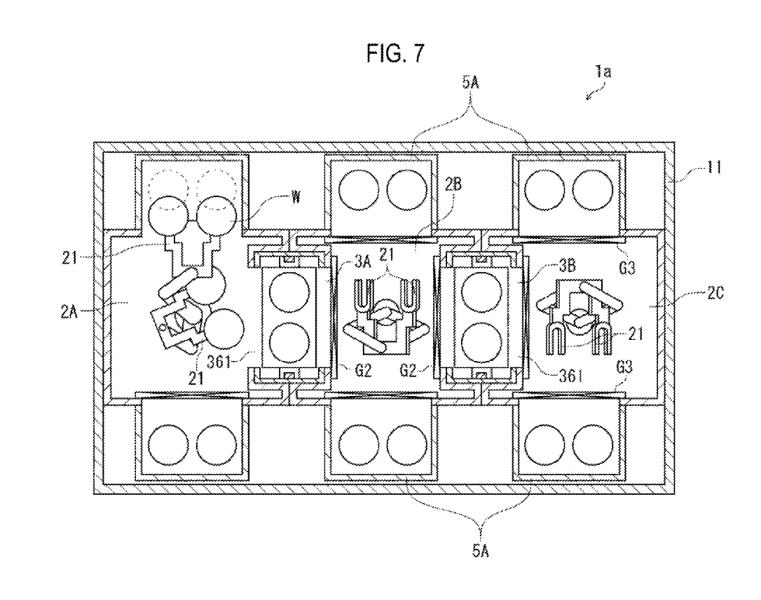

The configuration of the film forming modules 5 applied to the substrate processing apparatus 1 is not limited to those shown in FIGS. 3 and 4. FIG. 7 is a traverse cross-sectional view of a film forming apparatus la according to another embodiment. As shown in FIG. 7, the film forming apparatus la according to another embodiment includes film forming modules 5A different from those shown in FIG. 3. In the film forming modules 5A, a film forming process may be performed using an ALD method by mounting wafers W to be processed on a fixed mounting table and selectively supplying different kinds of reaction gases into a processing container (processing chamber). The film formation method is not limited to the ALD method. As an example, the present disclosure may be applied to film forming modules using various CVD methods such as a thermal CVD method of forming a thin film by continuously supplying a metal source into a processing container and decomposing the metal source on a surface of a heated wafer W, a plasma CVD method of performing a continuous film formation by activating a metal source, a reaction gas and the like under the presence of plasma to react them with each other.

The type of vacuum processing is not limited to the aforementioned film forming modules. In some embodiments, other processing container (vacuum chamber) such as an etching module which is configured to etch a thin film formed on a surface of a wafer W using an etching gas, a plasma ashing module which is configured to decompose and remove a resist film formed on the surface of the wafer W using plasma after the etching, and the like, may be connected to the aforementioned vacuum transfer chambers 2A to 2C.

Next, a variation of the vacuum transfer chambers 2A to 2C and the load lock chambers 3A and 3C will be described. While in the above embodiment shown in FIGS. 1 to 3, the three vacuum transfer chambers 2A to 2C has been described to be arranged adjacent to each other in a line and the two load lock chambers 3A and 3B has been described to be respectively sandwiched between the vacuum transfer chambers 2A-2B and 2B-2C, such a combined arrangement of the vacuum transfer chambers and the load lock chambers is not limited thereto. As long as one load lock chamber is sandwiched between at least two vacuum transfer chambers (first and second vacuum transfer chambers), even when one of the at least two vacuum transfer chambers is stopped, a processing module (a processing chamber in which a vacuum processing is performed) connected to the remaining vacuum transfer chamber(s) can continue to be used.

In some embodiments, four or more vacuum transfer chambers may be arranged adjacent to each other in a line and three or more load lock chambers may be respectively sandwiched between the adjacent vacuum transfer chambers. In this case, any adjacent two of the four or more vacuum transfer chambers correspond to a “first vacuum transfer chamber” and a “second vacuum transfer chamber,” respectively. A vacuum transfer chamber (if any) arranged at the opposite side of the first vacuum transfer chamber with respect to the second vacuum transfer chamber corresponds to a “third vacuum transfer chamber.”

In addition, the number of the processing modules connected to each of the vacuum transfer chambers 2A to 2C is not limited to two. In some embodiments, the transfer arms 21 may be configured to laterally move within each of the vacuum transfer chambers 2A to 2C and three or more processing modules may be connected to the lateral side of each vacuum transfer chamber 2A to 2C. In some embodiments, the number of wafers W to be transferred by the transfer arms 21 and the vertical transfer arms 421, the number of the transfer arms 21 installed in the vacuum transfer chambers 2A to 2C, the number of the vertical transfer arms 421 installed in the vertical transfer mechanism 42, the number of the wafer mounting tables 31, the number of the wafers W to be mounted on the wafer mounting tables 31, the number and configuration of the carrier transfer mechanisms 44, may be appropriately varied depending on the number of wafers W to be processed per unit time, or the like.

The present disclosure is not limited to the semiconductor wafers, and may be applied to a substrate processing apparatus which performs a vacuum processing onto rectangular substrates used in manufacturing flat panels.

According to some embodiments, since substrates are transferred between a load lock chamber and a normal pressure atmosphere at upper sides of first and second vacuum transfer chambers, it is possible to arrange the first and second vacuum transfer chambers and the load lock chamber in a restricted area with high efficiency.

Further, the first and second vacuum transfer chambers are laterally arranged adjacent to each other, the load lock chamber is installed to be sandwiched between the first and second vacuum transfer chambers. Further, partition valves are installed between the normal pressure atmosphere and the first and second vacuum transfer chambers. Accordingly, it is possible to independently separating the first and second vacuum transfer chambers from the load lock chamber. This allows, even when one of the first and second vacuum transfer chambers is not used, the other vacuum transfer chamber to continue to be used, which makes it possible to allow a substrate processing to continuously be performed using a processing chamber connected to the other vacuum transfer chamber.

While certain embodiments have been described, these embodiments have been presented by way of example only, and are not intended to limit the scope of the disclosures. Indeed, the novel methods and apparatuses described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A substrate processing apparatus comprising:
first and second vacuum transfer chambers which are air-tightly partitioned from each other and are laterally arranged adjacent to each other, each being equipped with a substrate transfer mechanism;
processing chambers configured to perform a vacuum processing onto substrates, the processing chambers being laterally arranged to be air-tightly connected to each of the first and second vacuum transfer chambers;
a first load lock chamber installed to be sandwiched between the first and second vacuum transfer chambers, and including a first set of partition valves installed between the first load lock chamber and a normal pressure atmosphere kept at upper sides of the first and second vacuum transfer chambers, and between the first load lock chamber and each of the first and second vacuum transfer chambers; and
substrate mounting tables provided within the first load lock chamber and configured to move between an upper position at which the substrates are transferred between the first load lock chamber and the normal pressure atmosphere, and a lower position at which the substrates are transferred between the first load lock chamber and the first or second vacuum transfer chamber, the substrates being horizontally mounted on the substrate mounting tables.

2. The substrate processing apparatus of claim 1, further comprising:
a container mounting table provided above any one of the first vacuum transfer chamber, the second vacuum transfer chamber and the first load lock chamber, and configured to mount a transfer container for receiving and transferring the substrates; and
a vertically-movable vertical transfer mechanism configured to transfer the substrates between the transfer container mounted on the container mounting table and a substrate mounting table among the substrate mounting tables placed at the upper position within the first load lock chamber.

3. The substrate processing apparatus of claim 1, further comprising:
a container transfer mechanism configured to transfer the transfer container between the container mounting table and a loading/unloading port through which the transfer container is transferred by a ceiling transfer mechanism installed inside a factory.

4. The substrate processing apparatus of claim 3, further comprising an intermediate delivery table provided in a transfer path formed between the loading/unloading port and the container mounting table, wherein the container transfer mechanism is configured to transfer the transfer container between the container transfer mechanism and the intermediate delivery table, and wherein the container transfer mechanism includes:
a main transfer mechanism configured to travel along a traveling path member provided over the loading/unloading port, the intermediate delivery table and the container mounting table;
and a sub transfer mechanism provided in the main transfer mechanism, and configured to transfer the transfer container between the loading/unloading port, the intermediate delivery table and the container mounting table.

5. The substrate processing apparatus of claim 1, further comprising:
a third vacuum transfer chamber provided at the opposite side of the first vacuum transfer chamber with the second vacuum transfer chamber interposed between the first and third vacuum transfer chambers, the third vacuum transfer chamber being air-tightly partitioned from the second vacuum transfer chamber;
a processing chamber air-tightly connected to lateral sides of the third vacuum transfer chamber, and configured to perform the vacuum processing on the substrates; and
a second load lock chamber installed to be sandwiched between the second and third vacuum transfer chambers, and including a second set of partition valves installed between the second load lock chamber and the normal pressure atmosphere kept at the upper sides of the second and third vacuum transfer chambers, and between the second load lock chamber and each of the second and third vacuum transfer chambers.

6. The substrate processing apparatus of claim 1, wherein the processing chamber is configured to perform a substrate processing on the substrates circumferentially arranged on a horizontally rotatable table while rotating the rotatable table.
